(19) United States
(12) Patent Application Publication
(10) Pub. No.: US 2008/0095876 A1
(43) Pub. Date: Apr. 24, 2008

(54) Seal of a barrel assembly

(75) Inventor: Valentin Diaconu, Etobicoke (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, US

(73) Assignee: Husky Injection Molding Systems Ltd.

(21) Appl. No.: 11/503,026

(22) Filed: Aug. 11, 2006

(51) Int. Cl. B29C 45/62

(52) U.S. Cl. 425/182

(57) ABSTRACT

Disclosed, amongst other things, is: (i) a seal of a barrel assembly for a molding system; (ii) for a molding system, a barrel assembly including a seal, (iii) a molding system with a barrel assembly including a seal, (iv) a method of a molding system for controllably sealing an interface defined in a barrel assembly, amongst other things.

### TECHNICAL FIELD

The present invention generally relates to, but is not limited to, molding systems, and more specifically the present invention relates to, but is not limited to, (i) a seal of a barrel assembly of a molding system, (ii) for a molding system, a barrel assembly including a seal, (iii) a molding system with a barrel assembly including a seal, (iv) a method of a molding system for controllably sealing an interface defined in a barrel assembly, amongst other things.

### BACKGROUND

With reference to FIG. 1 an exemplary metal injection molding system 10 is shown. The molding system 10 includes an injection unit 14 and a clamp unit 12.

The injection unit 14 processes a metal molding material (not shown) into a melt that is in at least a partially molten state. The injection unit 14 subsequently injects the melt into a closed and clamped injection mold, arranged in the clamp unit 12, in fluid communication therewith. The injection mold is shown in an open configuration in FIG. 1 and comprises complementary mold hot and cold halves 23 and 25. The injection unit 14 further includes an injection unit base 28 which slidably supports an injection assembly 29 mounted thereon. The injection assembly 29 comprises a barrel assembly 38 arranged within a carriage assembly 34, and a drive assembly 36 mounted to the carriage assembly 34. The drive assembly 36 is mounted directly behind the barrel assembly 38, for the operation (i.e., rotation and reciprocation) of a screw 56 (FIG. 2) arranged within the barrel assembly 38. The injection assembly 29 is shown to be connected to a stationary platen 16 of the clamp unit 12, through the use of carriage cylinders 30.

The clamp unit 12 includes a clamp base 18 with the stationary platen 16 securely retained to an end thereof, a clamp block 22 slidably connected at an opposite end of the clamp base 18, and a moving platen 20 arranged to translate therebetween on a set of tie bars 32 that otherwise interconnect the stationary platen 16 and the clamp block 22. The clamp unit 12 further includes a structure (not shown) for actuating the moving platen 20 and for clamping of the mold halves 23, 25 together during the injection of the melt of molding material.

The injection mold includes a molding cavity (not shown) formed between complementary molding inserts shared between the mold halves 23, 25. The mold half 25 includes a runner system 26 that connects a melt passageway 48 (FIG. 2) of the barrel assembly 38 with the molding cavity for the filling thereof.

With reference to FIG. 2, a exemplary embodiment of a known barrel assembly 38 is shown. The barrel assembly 38 includes a barrel head 42 that is positioned intermediate a machine nozzle 44 and a front end of a barrel 40. A melt passageway 48 extends through the components of the barrel assembly 38. The melt passageway 48 of the barrel 40 is disposed along a liner 46 made from a corrosion resistant material, such as STELLITE (a trademark of Deloro Stellite, Inc.) to protect the barrel substrate material, commonly made from a nickel-based alloy such as INCONEL, from the corrosive properties of the molding material. The components of the barrel assembly 38 are shown to be held together, at least in part, through the use of fasteners 51. The barrel 40, barrel head 42, and the machine nozzle 44 each include a heating structure 50 for controlling the molding material in the melt passageway 48 at a processing temperature. A screw assembly 56 is shown arranged in melt passageway 48 of the barrel assembly 38 for processing of the molding material.

The connection between the barrel 40 and the barrel head 42, and likewise the barrel head 43 and the machine nozzle 44, of the exemplary barrel assembly 38, is provided at an interface between interposed complementary spigot portions 71, 71′. A face seal configured at the interface between the spigot portions 71, 71′, under an applied sealing force provided by carriage cylinders 30, is intended to control leakage of molding material.

The connection between the machine nozzle 44 and a sprue bushing 70 of the runner system 26 is shown in general accordance with the teachings of U.S. Pat. No. 6,357,511 (Inventor: KESTLE, Martin; et al. Published: 19 Mar., 2002). In particular, the connection includes a portion of the machine nozzle 44 fitting inside a portion of the sprue bushing 70. In operation, the portions are separated by a small gap that permits a limited amount of metallic material to flow into the gap and solidify to form a seal.

Further detail regarding the exemplary structure and operation of the molding system 10 may be referenced, for example, in United States published patent application No. 2005/0255189 (Inventor: MANDA, Jan; et al. Published: 17 Nov., 2005). The patent publication also describes a cooled connection between melt conduits of a runner system to form a seal of at least partially solidified molding material.

World Intellectual Property Organization Patent Number WO 9500312 (Inventor: WOLFF; Published: 1995 Jan. 5) discloses a hot runner distributor for supplying molten thermoplastic materials to hot nozzles at molding tools that has pipe plug-type connections that allow thermal expansion. Each pipe plug-type connection has two mutually aligned pipe ends which surround the runner of molten material and are mutually separated by an expandable joint. Both pipe ends are enclosed in the area of the expandable joint by a common cooling ring. The molten plastic material which solidifies under the action of the cooling ring seals the pipe plug-type connection in the area of the expandable joint.

### SUMMARY

According to a first aspect of the present invention, there is provided a seal defined in a barrel assembly including a cooling structure configured to controllably cool molding material at an interface thereby controlling leakage of molding material at the interface.

According to a second aspect of the present invention, there is provided a barrel assembly including a seal defined in the barrel assembly, the seal including a cooling structure configured to controllably cool molding material at an interface thereby controlling leakage of molding material at the interface.

According to a third aspect of the present invention, there is provided a molding system including a seal defined in a barrel assembly, the seal including a cooling structure configured to controllably cool molding material at an interface thereby controlling leakage of molding material at the interface.

According to a fourth aspect of the present invention, there is provided a method of a molding system for controllably sealing an interface defined in a barrel assembly with a seal including circulating a coolant in a cooling structure configured to controllably cool molding material at the interface thereby controlling leakage of molding material at the interface.

A technical effect, amongst others, of the aspects of the present invention is the provision of a seal of a metal molding system that controls leaking of the molding material at an interface defined in the barrel assembly.

Preferable embodiments of the present invention are subject of the dependent claims.

### BRIEF DESCRIPTION OF THE DRAWINGS

A better understanding of the exemplary embodiments of the present invention (including alternatives and/or variations thereof) may be obtained with reference to the detailed description of the exemplary embodiments along with the following drawings, in which:

FIG. 1 is a side view a metal molding system;

FIG. 2 is a partial section of a portion of FIG. 1 illustrating the construction of an exemplary embodiment of a known barrel assembly;

FIG. 3A is a cross-section view of an exemplary embodiment of a barrel assembly in accordance with the present invention;

FIG. 3B is a detailed view of an exemplary embodiment of a seal in accordance with the present invention that is configured between components of the barrel assembly of FIG. 3A.

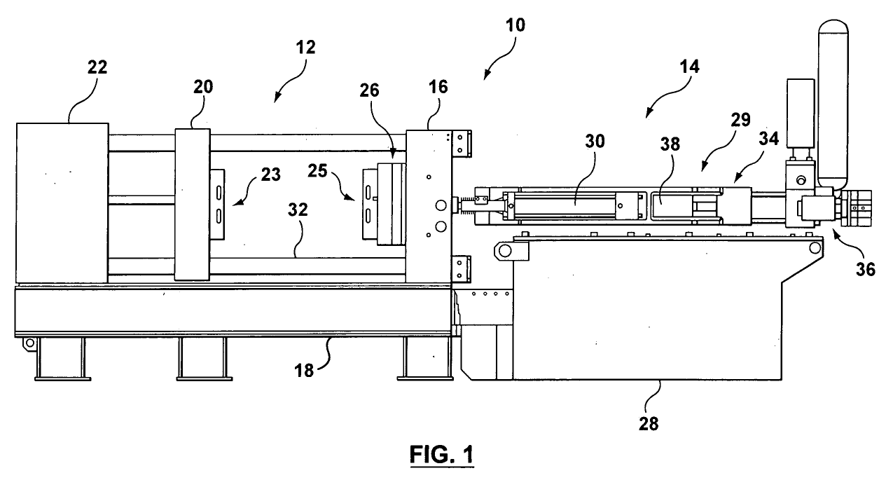

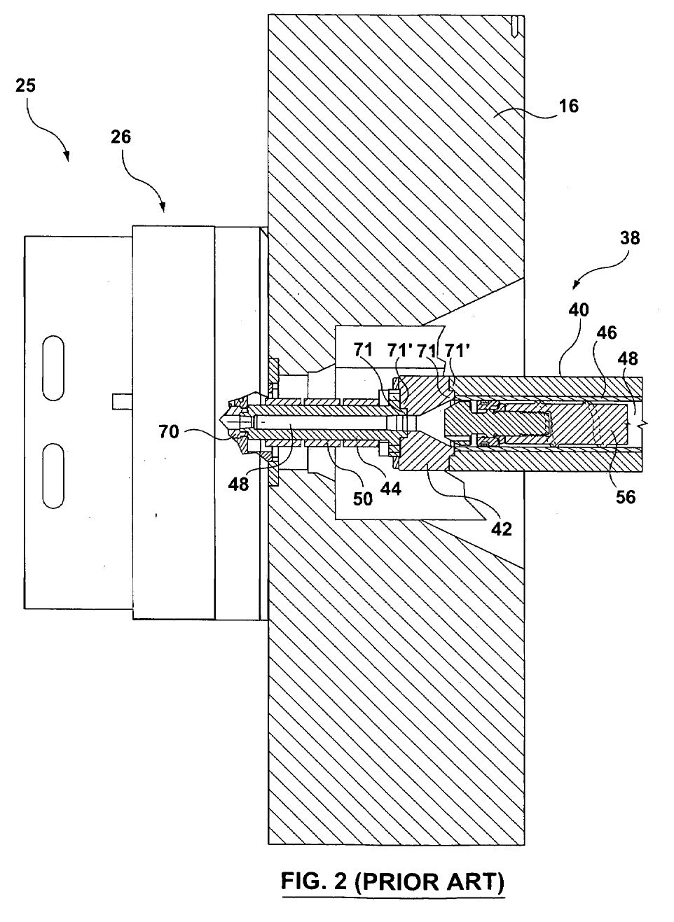

The drawings are not necessarily to scale and are may be illustrated by phantom lines, diagrammatic representations and fragmentary views. In certain instances, details that are not necessary for an understanding of the exemplary embodiments or that render other details difficult to perceive may have been omitted.

### DETAILED DESCRIPTION OF THE EXEMPLARY EMBODIMENTS

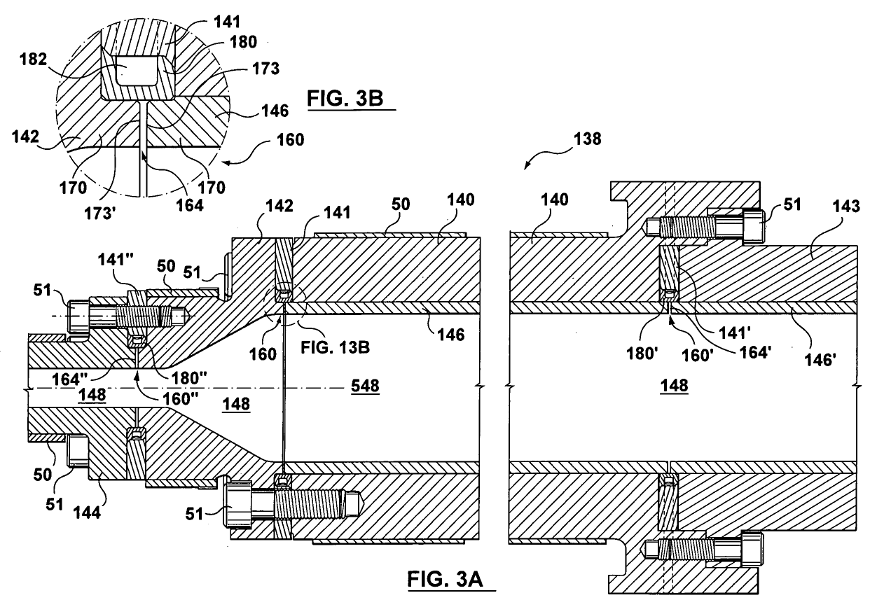

With reference to FIGS. 3A and 3B, an exemplary embodiment of a seal 160 according an exemplary embodiment of a barrel assembly 138. In accordance with the exemplary embodiment of the barrel assembly 138, the seal 160 is configured at an interface 164 defined between a barrel head 142 and a first barrel portion 140. Likewise, a seal 160′ may also be configured at an interface defined between the first barrel portion 140 and a second barrel portion 143. As a further example, a seal 160″ may configured at an interface defined between the barrel head 142 and a machine nozzle 144. Accordingly, the barrel assembly 138 may include the seal 160, and variants thereto, at an interface between any combination, and permutation, of components of the barrel assembly 138.

The exemplary embodiment of the barrel assembly 138 includes a melt passageway 148 that extends through the components of the barrel assembly 148. The melt passageway 148 of the first and second barrel portions 140, 143 is disposed along a liner 146, 146′ made from a corrosion resistant material, such as STELLITE to protect the barrel substrate material, commonly made from a nickel-based alloy such as INCONEL, from the corrosive properties of the molding material. The components of the barrel assembly 138 are shown to be held together, at least in part, through the use of fasteners 51. The first and second barrel portions 140, 143, the barrel head 142, and the machine nozzle 144 may include a heating structure 50 for controlling the temperature of the molding material in the melt passageway 148.

The exemplary barrel assembly 138 further includes a cooling structure 180 that is arranged to overlap flange portions at the interface 164 of the barrel head 142 and barrel liner 146 to provide alignment therebetween and to cool an interface 164 defined between adjacent annular faces 173, 173′ of the barrel head 142 and the barrel liner 146. The cooling structure 180 is preferably an annular body with a coolant channel 182 defined therein. The cooling structure 180 preferably includes a temperature monitoring structure (not shown), such as a thermocouple, to provide temperature feedback to a controller (not shown) in order that a flow and temperature of the coolant to the channel 182 may be controlled to effect a temperature control of the interface 164. The exemplary barrel assembly 138 further includes an auxiliary member 141 that surrounds the cooling structure 180 as a structural spacer. Preferably, the interface 164 includes a small gap between the annular faces 173, 173′ when the barrel head 142 and first barrel portion 140 have been controllably heated to a processing temperature.

Alternatively, the interface 164 is configured (not shown) such that there is no gap between the annular faces 173, 173′ when the barrel head 142 and first barrel portion 140 have been controllably heated to the processing temperature. The interface 164 may be further configured such that there is a face seal between the annular faces 173, 173′, with a sealing force acting therebetween, when the barrel head 142 and first barrel portion 140 have been controllably heated to the processing temperature.

Likewise, a cooling structure 180′ may also be arranged to overlap flange portions of the barrel liner 146, 146′ projecting from the mating ends the first and the second barrel portion 140, 143. The cooling structure 180′ preferably aligns the first and second barrel portions 140, 143, and also cools an interface 164′ defined between adjacent annular faces of the barrel liners 146, 146′. An auxiliary member 141′ surrounds the cooling structure 180′ as a structural spacer. Alternatively, other means, such as dowels, may be provided to align the first and second barrel portions 140, 143.

Likewise, a cooling structure 180″ may be arranged to overlap flange portions at the interface of the barrel head 142 and machine nozzle 144 to provide alignment therebetween and to cool an interface 164″ defined between adjacent annular faces of the barrel head 142 and the machine nozzle 144. An auxiliary member 141″ surrounds the cooling structure 180″ as a structural spacer.

A technical effect of a controlled cooling of the interface 164, 164′, 164″ is a corresponding control of the viscosity of the molding material in the vicinity of the interface 164, 164′, 164″ for controlling the leakage of molding material therethrough. Preferably, the cooling structure 180 controllably cools the interface 164 sufficiently to form a seal 160, 160′, 160″ of at least partially solidified molding material in the vicinity of the interfaces 164, 164′, 164″.

In accordance with an exemplary alternative embodiment the barrel assembly (not shown) in a two-stage injection unit (not shown), the seal 160, and variants thereto, may also be used at an interface between the barrel assembly and a shooting pot (not shown).

In accordance with another exemplary alternative embodiment the barrel assembly (not shown) the cooling structure is integrally formed with one, or both, of the barrel components to be sealed.

In accordance with yet another exemplary alternative embodiment the barrel assembly (not shown) the cooling structure recessed into one, or both, of the barrel components to be sealed and in so doing the auxiliary member is no longer required.

The description of the exemplary embodiments provides examples of the present invention, and these examples do not limit the scope of the present invention. It is understood that the scope of the present invention is limited by the claims. The concepts described above may be adapted for specific conditions and/or functions, and may be further extended to a variety of other applications that are within the scope of the present invention. Having thus described the exemplary embodiments, it will be apparent that modifications and enhancements are possible without departing from the concepts as described. Therefore, what is to be protected by way of letters patent are limited only by the scope of the following claims:

What is claimed is:

1. A seal defined in a barrel assembly of a molding system, comprising:
a cooling structure configured to controllably cool molding material at an interface thereby controlling leakage of molding material at the interface.

2. The seal of claim 1, wherein the cooling structure configured to controllably cool the interface to control the viscosity of the molding material in the vicinity of the interface.

3. The seal of claim 2, wherein the cooling structure configured to controllably cool the interface sufficiently to solidify, at least partially, molding material in the vicinity of the interface.

4. The seal of claim 1, wherein the interface is defined between any of:
a first barrel portion,
a second barrel portion,
a barrel liner,
barrel head,
a machine nozzle,
an auxiliary member,
a cooling structure, and
any combination and permutation thereof.

5. A barrel assembly of a molding system, comprising:
a seal defined in the barrel assembly, the seal including a cooling structure configured to controllably cool molding material at an interface thereby controlling leakage of molding material at the interface.

6. The barrel assembly of claim 5, wherein the cooling structure configured to controllably cool the interface to control the viscosity of the molding material in the vicinity of the interface.

7. The barrel assembly of claim 6, wherein the cooling structure configured to controllably cool the interface sufficiently to solidify, at least partially, molding material in the vicinity of the interface.

8. The barrel assembly of claim 5, wherein the interface is defined between any of:
a first barrel portion,
a second barrel portion,
a barrel liner,
a barrel head,
a machine nozzle,
an auxiliary member,
a cooling structure, and
any combination and permutation thereof.

9. A molding system, comprising:
a barrel assembly; and
a seal defined in the barrel assembly, the seal including a cooling structure configured to controllably cool molding material at an interface thereby controlling leakage of molding material at the interface.

10. The molding system of claim 9, wherein the cooling structure configured to controllably cool the interface to control the viscosity of the molding material in the vicinity of the interface.

11. The molding system of claim 10, wherein the cooling structure configured to controllably cool the interface sufficiently to solidify, at least partially, molding material in the vicinity of the interface.

12. The molding system of claim 9, wherein the interface is defined between any of:
a first barrel portion,
a second barrel portion,
a barrel liner,
a barrel head,
a machine nozzle,
an auxiliary member,
a cooling structure, and
any combination and permutation thereof.

13. A method of a molding system, comprising:
sealing an interface defined in a barrel assembly of a molding system with a seal including circulating a coolant in a cooling structure configured to controllably cool molding material at the interface thereby controlling leakage of molding material at the interface.

14. The method of claim 13, further comprising:
controllably cooling the interface to control the viscosity of the molding material in the vicinity of the interface.

15. The method of claim 14, wherein the controllable cooling of the cooling structure solidifies, at least partially, the molding material in the vicinity of the interface.

16. The method of claim 13, wherein the interface is defined between any of:
a first barrel portion,
a second barrel portion,
a barrel liner,
a barrel head,
a machine nozzle,
an auxiliary member,
a cooling structure, and
any combination and permutation thereof.
